(19) United States
(12) Patent Application Publication
(10) Pub. No.: US 2009/0088237 A1
(43) Pub. Date: Apr. 2, 2009

(54) POKER GAME APPARATUS WITH REAL TIME POKER CARD PRINTING DEVICES

(76) Inventor: Tien-Shu Hsu, Taichung (TW)

Correspondence Address: BURR & BROWN, PO BOX 7068, SYRACUSE, NY, 13261-7068, US

(21) Appl. No.: 11/865,370

(22) Filed: Oct. 1, 2007

(51) Int. Cl. A63F 13/00; A63F 1/00

(52) U.S. Cl. 463/12; 463/13; 463/42

(57) ABSTRACT

A poker game apparatus with real time poker card printing devices has a gaming server apparatus, multiple user interfaces and multiple poker generating devices. The gaming server apparatus runs a poker game program, deals cards and identifies images of the cards after the cards are dealt. Each user interface is electrically connected to the gaming server apparatus, corresponds to a person, displays status of the poker game program to the person and accepts keyed in commands the person to control the poker game program. Each poker-generating device is electrically connected to one of the user interfaces, is controlled by the corresponded user interface to print a particular card image on a blank card for the corresponding person. The person can take a glance at the particular card image when he gets the printed card.

### BACKGROUND OF THE INVENTION

1. Field of Invention

The present invention relates to a poker game apparatus, and more particularly to a poker game apparatus with real time poker card printing devices.

2. Description of the Related Art

Consumer electronic technologies are used widely for entertainment. Many kinds of electronic game machines are provided. For instance, an electronic poker game apparatus in a casino is popular because the electronic poker game apparatus is fun and easy to use. Normally, the electronic poker game apparatus comprises a user interface and a server. A player seats in front of the user interface. The user interface receives images of cards dealt from the server to the player and accepts wagers from the player. Even though the electronic poker game apparatus may be convenient to play, the player cannot hold real poker cards during play and cannot take a glance at a hole card to enjoy the fun and reality of holding real cards.

The present invention provides a poker game apparatus with real time poker card printing devices to obviate or mitigate the shortcomings of the conventional electronic poker game apparatus.

### SUMMARY OF THE INVENTION

The primary objective of the present invention is to provide a poker game apparatus with real time poker card printing devices to improve entertainment and reality of playing the poker game apparatus.

The poker game apparatus with real time poker card printing devices in accordance with the present invention has a gaming server apparatus, multiple user interfaces and multiple poker generating devices. The gaming server apparatus runs a poker game program, deals cards and provides images of the cards after they are dealt. Each user interface is electrically connected to the gaming server apparatus, corresponds to a person, displays status of the poker game program to the person and accepts commands to control the poker game program from the person. Each poker-generating device is electrically connected to one of the user interfaces, is controlled by the corresponding user interface to print a particular card image on a blank card for the corresponding person. The person can take a glance at the particular card image when he gets the printed card.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a poker game apparatus with real time poker card printing devices in accordance with the present invention;

FIG. 2 is an operational top view of the poker game apparatus in FIG. 1; and

FIG. 3 is a logic diagram of a poker game program used in the poker game apparatus in FIG. 1.

### DETAILED DESCRIPTION OF THE INVENTION

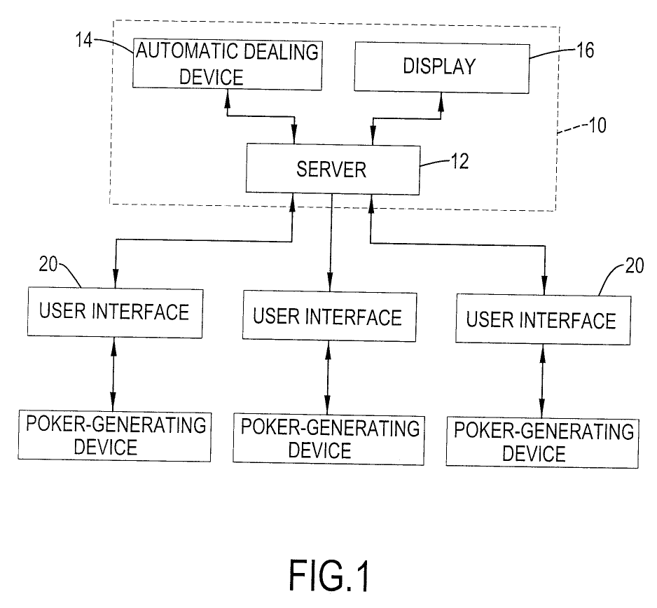

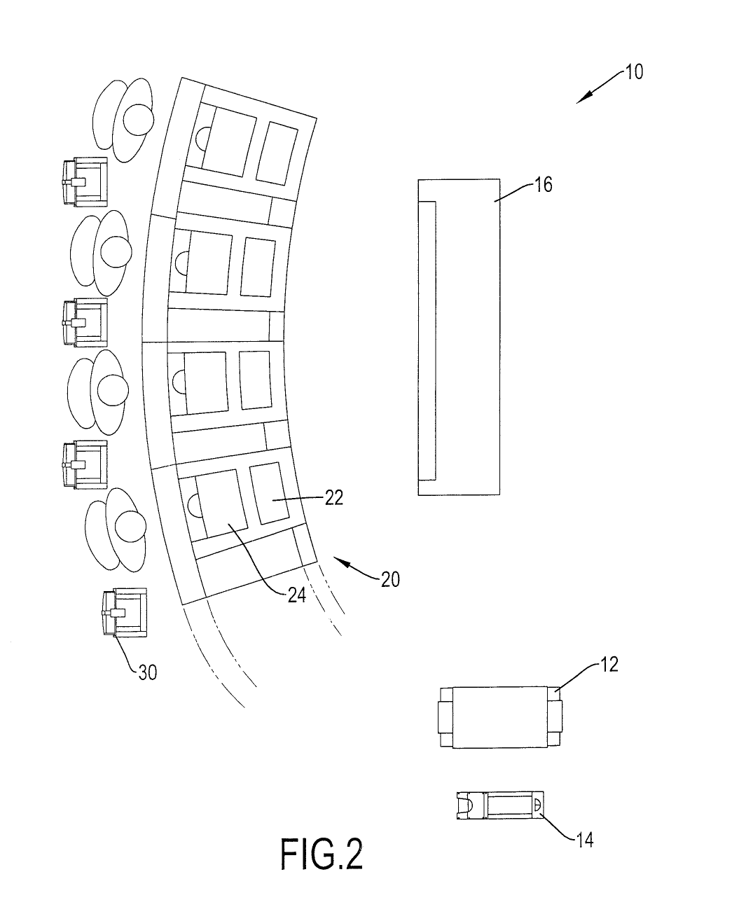

With reference to FIGS. 1 and 2, a poker game apparatus with real time poker card printing devices in accordance with the present invention comprises a gaming server apparatus (10), multiple user interfaces (20) and multiple poker-generating devices (30).

The gaming server apparatus (10) has a server (12), an automatic dealing device (14) and an optional display (16). The server (12) runs a poker game program. The poker game program may be baccarat, blackjack or the like.

The automatic dealing device (14) is electrically connected to and controlled by the server (12), deals cards automatically, identifies card images after the cards are dealt, sends the card images to the server (12) after the cards are identified and may be an automatic card dealing machine with an image identifier, a drawing machine with an image identifier, a random number generator (RNG) with an image identifier or the like. In a preferred embodiment of the present invention, the automatic dealing device (14) is an automatic card dealing machine with an image identifier.

The display (16) is electrically connected to the server (12), is an electronic display such as cathode ray tube display, liquid crystal display or the like and displays status of the poker game program.

The user interfaces (20) are electrically connected to the server (12), and each user interface (20) corresponds to a person, receives a status of the poker game program from the server (12), accepts an inputted command from the person to control the poker game program and may have an output interface (22) and an input interface (24). The output interface (22) may be an electronic display that displays the status of the poker game program to the person. The input interface (24) is a keyboard that accepts commands keyed in by the person to control the status of the poker game program.

Each poker-generating device (30) may be electrically connected to one of the user interfaces (20) or may be electrically connected to the server (12), may hold multiple blank cards inside, is controlled by the server (12), prints a particular card image on one of the blank poker cards and outputs a printed poker card to the person. The poker-generating device (30) may be a laser printer, a heat transfer printer or the like.

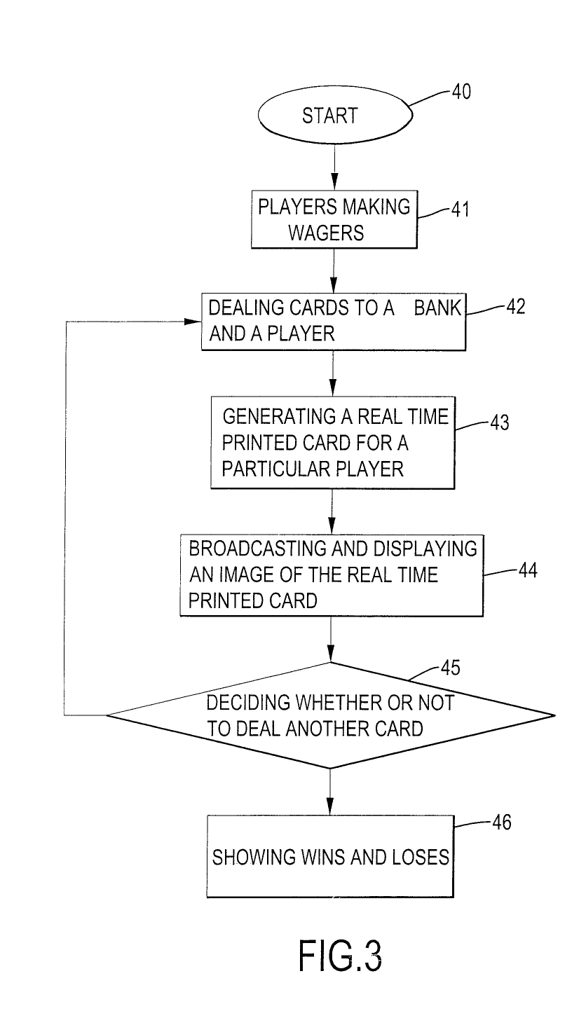

With reference to FIG. 3, the poker game program of the preferred embodiment of the present invention is a Baccarat poker game program with steps comprising players making wagers (41), dealing cards to a BANK and a PLAYER (42), generating a real time printed card for a particular player (43), broadcasting and displaying an image of the real time printed card (44), deciding whether or not to deal another card (45) and showing wins and loses (46).

In the step of players making wagers (41), players wager on the BANK, the PLAYER or TIE by using the corresponding user interface (20).

In the step of dealing cards to the BANK and PLAYER (42), the automatic dealing device (14) deals at least one poker card to the BANK and the PLAYER first, then sends images of the dealt cards to the server (12) after the cards are identified.

In the step of generating a real time printed card for a particular player (43), the server (12) chooses a particular player (may be a player with the largest wager) to send one of the images of the dealt cards to the particular player's user interface (20) or the poker-generating device (30). The poker-generating device (30) then prints and outputs a printed card for the particular player, where the image printed on the blank card is the image of one of the dealt cards. After receiving the printed card, the particular player can glance at the image printed on the printed card, which is just like playing a real poker game.

In the step of broadcasting and displaying an image of the real time printed card (44), the server (12) broadcasts the image printed on the printed card to all user interfaces (20) and displays the image on the display (16) or all output interfaces (22) to each player after the particular player has glanced at the printed card.

In the step of decide whether or not to deal another poker card (45), the server (12) decides whether to deal another card to the BANK or PLAYER depending on the cards dealt. If the BANK or PLAYER needs another card, the server (12) will then repeat the step of dealing cards to the BANKER and PLAYER (42).

In the step of showing wins and loses (46), the server (12) judges whether the BANK or PLAYER is a winner or if a TIE situation has occurred and calculates wins and loses of each player.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A poker game apparatus with real time poker card printing devices comprising
a gaming server apparatus having
a server running a poker game program; and
an automatic dealing device being electrically connected to and being controlled by the server, dealing cards automatically, identifying card images after the cards are dealt and sending the card images to the server after the cards are identified;
multiple user interfaces being electrically connected to the server, and each user interface receiving a status of the poker game program from the server and accepting an inputted command from a person to control the poker game program; and
multiple poker-generating device being controlled by the server to print a particular card image on a blank card and outputting a printed card to the person.

2. The poker game apparatus as claimed in claim 1, wherein the poker game program is Baccarat.

3. The poker game apparatus as claimed in claim 1, wherein the poker game program is blackjack.

4. The poker game apparatus as claimed in claim 1, wherein the automatic dealing device is an automatic poker card dealing machine with an image identifier, a drawing machine with an image identifier or a random number generator with an image identifier.

5. The poker game apparatus as claimed in claim 1, wherein the gaming server apparatus further has a display being electrically connected to the server and displaying status of the poker game program.

6. The poker game apparatus as claimed in claim 1, wherein each user interface has
an output interface being an electronic display displaying status of the poker game program; and
an input interface being a keyboard and accepting commands keyed in by the person to control the status of the poker game program.

7. The poker game apparatus as claimed in claim 1, wherein each poker-generating device is electrically connected to one of the user interfaces.

8. The poker game apparatus as claimed in claim 1, wherein each poker-generating device is electrically connected the server.

9. The poker game apparatus as claimed in claim 1, wherein the poker-generating device is a laser printer or a heat transfer printer.

10. The poker game apparatus as claimed in claim 4, wherein each user interface has
an output interface being an electronic display displaying status of the poker game program; and
an input interface being a keyboard and accepting commands keyed in by the person to control the status of the poker game program.

11. The poker game apparatus as claimed in claim 9, wherein the poker-generating device holds multiple blank cards.
